(19) United States
(12) Patent Application Publication
(10) Pub. No.: US 2018/0011227 A1
(43) Pub. Date: Jan. 11, 2018

(54) FOCUSING METHOD AND FOCUSING APPARATUS

(71) Applicant: LUSTROUS ELECTRO-OPTIC CO.,LTD., New Taipei City (TW)

(72) Inventor: CHIH-WEI TSAI, HSINCHU CITY (TW)

(21) Appl. No.: 15/202,776

(22) Filed: Jul. 6, 2016

(51) Int. Cl. G02B 3/14; G03B 13/36; G02B 7/09

(52) U.S. Cl. CPC G02B 3/14; G02B 7/09; G03B 13/36

(57) ABSTRACT

The instant disclosure provides a focusing method and a focusing apparatus. The focusing apparatus includes a lens device, an image capture device, a focal length adjustment device, and a control device. The lens device includes a liquid lens module and an optical lens module. The optical lens module is disposed corresponding to the liquid lens module. The image capturing device is disposed corresponding to the lens device. The focal length adjustment device is disposed on the optical lens module or the image capture device to drive the optical lens module or the image capture device and change the focal length of the optical lens module. The control device electrically connects the lens device, the image capture device, and the focal length adjustment device to control the focal length of the liquid lens module and the optical lens module.

### BACKGROUND

### 1. Technical Field

The instant disclosure relates to a focusing method and a focusing apparatus, in particular, to a focusing method and a focusing apparatus that are able to focus quickly.

### 2. Description of Related Art

Existing lens modules (such as those of smart phones, tablets, microscopes and barcode readers) generally adapt inactive auto-focusing, and the lens modules in the lens assembly are generally driven by the voice coil actuator (voice coil motor). However, the lens modules employing the voice coil actuators are limited by the design of the driving means and are able to focus only in a limited moving speed. In other words, when the lens modules employing the voice coil actuator exceeds a predetermined speed, the lens module will generate vibration. In addition, the focusing distance of the lens module will be affected by the design of the driving means and has a moving distance limitation.

Furthermore, although there is a liquid lens presented in the market, the liquid lens is not able to perform fine focal length adjustments within the focusing distance.

### SUMMARY

The problem to be solved in the instant disclosure is to provide a focusing method and a focusing apparatus for focusing quickly.

An exemplary embodiment of the present disclosure provides a focusing method comprising providing a focusing apparatus, the focusing apparatus comprises a liquid lens module and an optical lens module, in which the liquid lens module has a plurality of first predetermined focusing sections, the optical lens module has a plurality of second predetermined focusing sections; adjusting the focus length of the liquid lens module based on an object for focusing the liquid lens module in one of the first predetermined focusing sections as a range of a coarse tuning focus section; and adjusting the focal length of the optical lens module in the coarse tuning focus section for focusing the optical lens module in one of the second predetermined focusing sections as a range of a fine tuning focus section.

Another exemplary embodiment of the present disclosure provides a focusing apparatus comprising a lens device, an image capturing device, a focal length adjustment device and a control device. The liquid lens module comprises a liquid lens unit, an optical lens module and a central axis. The optical lens module is disposed correspondingly to the liquid lens module, in which the optical lens module comprises an optical lens unit. The central axis passes the liquid lens module and the optical lens module. The image capturing device is disposed correspondingly to the lens device. The focal length adjustment device is disposed on the optical lens module or the image capturing device for changing the focal length of the optical lens module. The control device electrically connects to the lens device, the image capturing device and the focal length adjustment device for controlling the focal length of the liquid lens module and the optical lens module.

The advantage of the instant disclosure is that by first utilizing the properties of high moving speed and large displacement of the focal length adjustment of the liquid lens module to roughly focus in a coarse tuning focus section comprising an object, then performing focusing process on the object in the range of the coarse tuning focus section by the optical lens module and utilizing the higher focusing accuracy of the optical lens module to focus the optical lens module in a fine tuning focusing section, a quick focusing process can be performed on the object.

In order to further understand the techniques, means and effects of the instant disclosure, the following detailed descriptions and appended drawings are hereby referred to, such that, and through which, the purposes, features and aspects of the instant disclosure can be thoroughly and concretely appreciated; however, the appended drawings are merely provided for reference and illustration, without any intention to be used for limiting the instant disclosure.

### BRIEF DESCRIPTION OF THE DRAWINGS

The accompanying drawings are included to provide a further understanding of the instant disclosure, and are incorporated in and constitute a part of this specification. The drawings illustrate exemplary embodiments of the instant disclosure and, together with the description, serve to explain the principles of the instant disclosure.

FIG. 1 is a module block diagram of the focusing apparatus of the embodiments of the instant disclosure.

FIG. 2 is a three-dimensional exploded schematic view of the focusing apparatus of the embodiments of the instant disclosure.

FIG. 3 is a three-dimensional assembled view of the focusing apparatus of the embodiments of the instant disclosure.

FIG. 4 is another three-dimensional exploded view of the focusing apparatus of the embodiments of the instant disclosure.

FIG. 5 is another three-dimensional assembled view of the focusing apparatus of the embodiments of the instant disclosure.

FIG. 6 is a schematic view of the focusing sections of the embodiments of the instant disclosure.

FIG. 7 is a schematic flow chart of the focusing method of the embodiments of the instant disclosure.

FIG. 8 is a schematic flow chart of step S102 of the focusing method of the embodiments of the instant disclosure.

FIG. 9 is a schematic flow chart of step S102′ of the focusing method of the embodiments of the instant disclosure.

### DESCRIPTION OF THE EXEMPLARY EMBODIMENTS

Reference will now be made in detail to the exemplary embodiments of the instant disclosure, examples of which are illustrated in the accompanying drawings. Wherever possible, the same reference numbers are used in the drawings and the description to refer to the same or like parts.

### First Embodiment

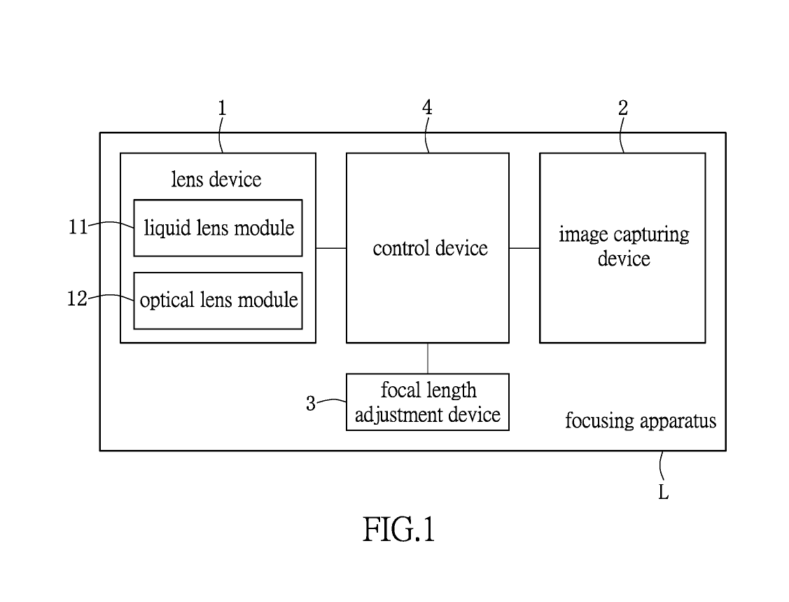

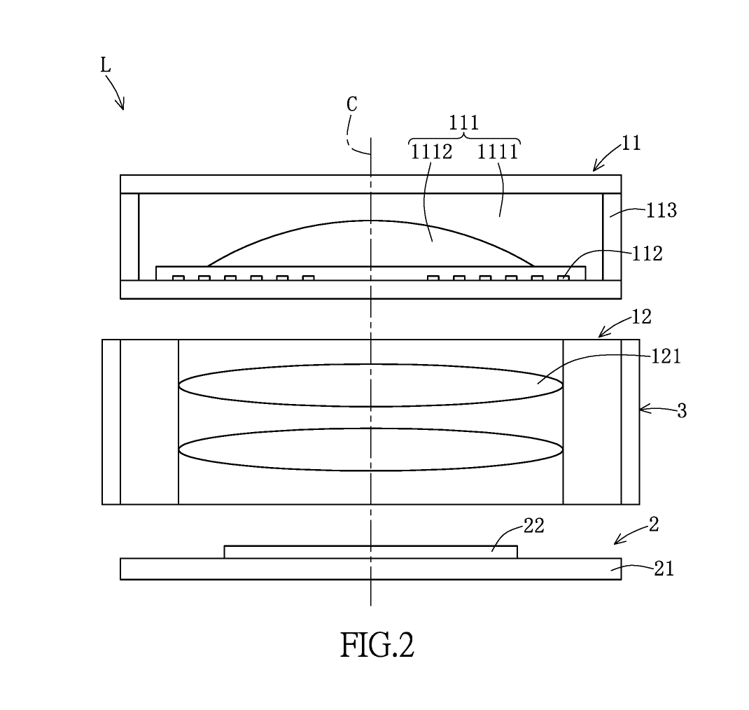

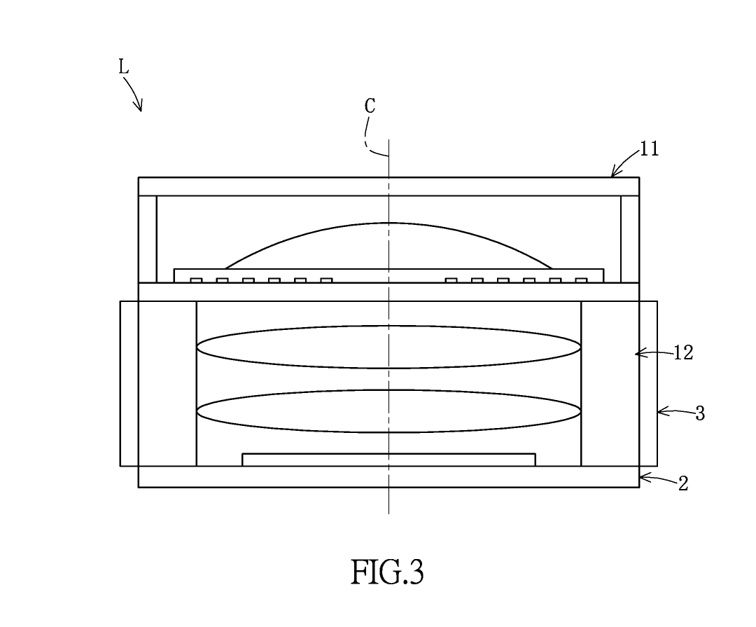

First, please refer to FIG. 1 to FIG. 5. The first embodiment of the instant disclosure provides a focusing apparatus L for capturing the image of an object (not shown). The focusing apparatus L comprises a lens device 1, an image capturing device 2, a focal length adjustment device 3 and a control device 4. The lens device 1 comprises a liquid lens module 11, an optical lens module 12 and a central axis C passing the liquid lens module 11 and the optical lens module 12, and the liquid lens module 11 and the optical lens module 12 both align to the central axis C. The liquid lens module 11 can be a dielectric liquid lens or an electrowetting liquid lens and comprises two immiscible transparent liquids (first liquid 1111 and second liquid 1112), a driving electrode 112 and a packing means 113. The liquid-liquid interface having a curvature formed by the two immiscible transparent liquids is an axil-symmetric spherical surface of the liquid lens. The driving electrode 112 is for generating an electric field to adjust the shape of the interface of the two immiscible liquids, thereby achieving the object of adjusting the focal length of the liquid lens. In addition, the packing means 113 is a means for encapsulating the two liquids. The optical lens module 12 is a lens set in the focusing apparatus of the existing art, i.e., the optical lens unit 121 in the optical lens module 12 is a lens set consisting of one or more solid glasses or one or more plastic lenses which are concave lenses or convex lenses. For description convenience, the liquid lens module 11 shown in FIG. 2 to FIG. 5 is a dielectric liquid lens.

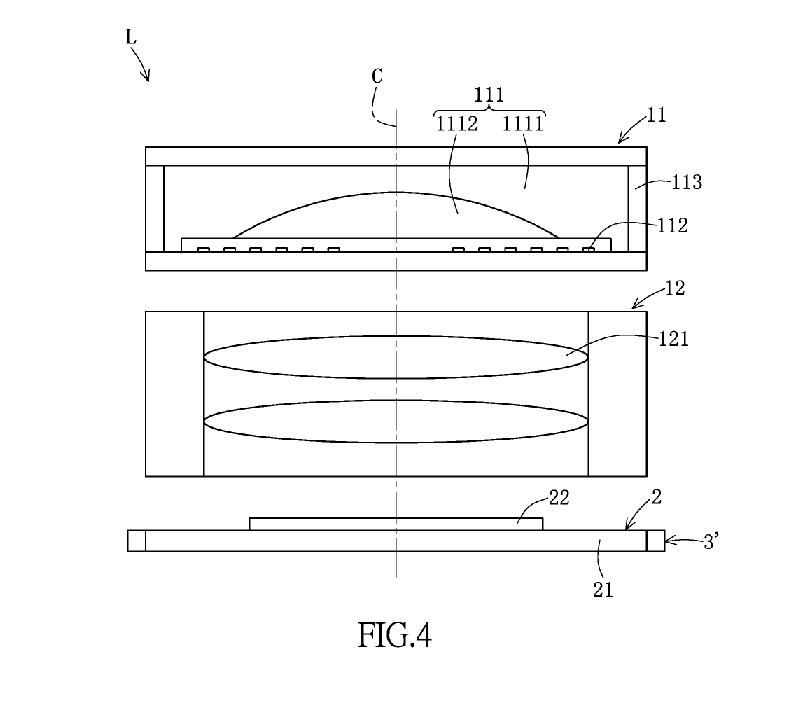

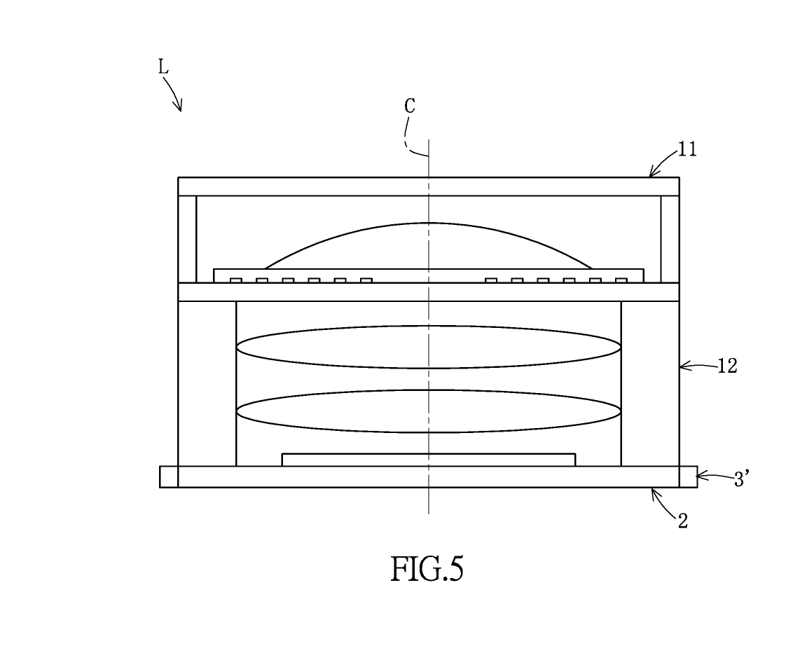

Please refer to FIG. 2 and FIG. 5. The image capturing device 2 is a charge-coupled device (CCD) or a complementary metal-oxide-semiconductor (CMOS), and the image capturing device 2 can be disposed corresponding to the lens device 1. The image capturing device 2 comprises a substrate 21 and a chip 22 disposed on the substrate 21. In addition, the focal length adjustment device 3 is disposed on the optical lens module 12 for driving the optical lens module 12 to move linearly to change the focal length of the optical lens module 12. However, in other embodiments, the focal length adjustment device 3′ can be disposed on the image capturing device 2 for driving the image capturing device 2 to move linearly to change the focal length of the optical lens module 12 as shown in FIG. 4 and FIG. 5. In other words, the focal length adjustment device 3 can be a voice coil actuator (voice coil motor) or other motor for driving the optical lens module 12 or the image capturing device 2 to move linearly. However, the instant disclosure is not limited thereto.

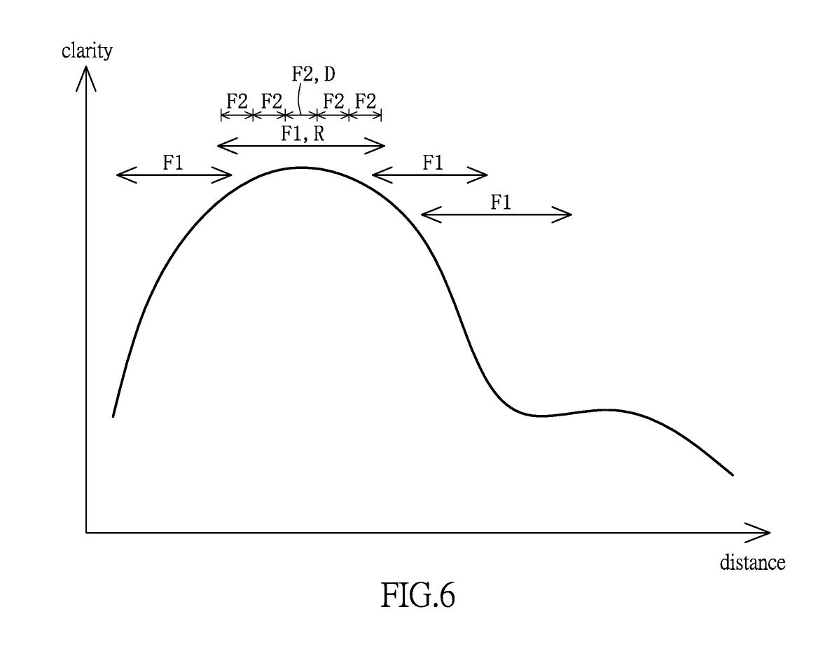

The liquid lens module 11 comprises a liquid lens unit 111 and the liquid lens unit 111 also has a plurality of predetermined focusing sections F1 (as shown in FIG. 6). The central axis C passes through the center point of the liquid lens unit 111. The liquid lens unit 111 consists of the first liquid 1111 and the second liquid 1112. In addition, the optical lens module 12 is disposed corresponding to the liquid lens module 11. The optical lens module 12 comprises a plurality of second predetermined focusing sections F2. The image capturing device 2 is disposed corresponding to the liquid lens module 11 and the optical lens module 12. The optical lens module 12 comprises an optical lens unit 121 and the central axis C passes the center point of the optical lens unit 121.

In the embodiments of the instant disclosure, the image capturing device 2 and the lens device 1 are disposed corresponding to each other. For instance, the optical lens module 12, the liquid lens module 11 and the image capturing device 2 are stacked on each other. In other words, the optical lens module 12 is disposed between the image capturing device 2 and the liquid lens module 11. However, in other embodiments, the liquid lens module 11 can be disposed between the image capturing device 2 and the optical lens module 12.

The control device 4 is electrically connected to the lens device 1, the image capturing device 2 and the focal length adjustment device 3 to control the focal length of the liquid lens module 11 and the optical lens module 12. Specifically, the control device 4 electrically connects to the driving electrode 112 of the liquid lens module 11 for inducing the driving electrode 112 to generate an electric field, thereby adjusting the curvature of the liquid lens unit 111. The control device 4 can also control the focal length adjustment device 3 (referred to as the voice coil motor hereinafter), and the voice coil motor starts to adjust the solid glass in the optical lens module 12 or the image capturing device 2. Therefore, by setting the focal length adjustment device 3, the focal length of the optical lens module 12 can be changed. The imaging of the object is projected on the image capturing device 2 by the liquid lens module 11 and the optical lens module 12.

### Second Embodiment

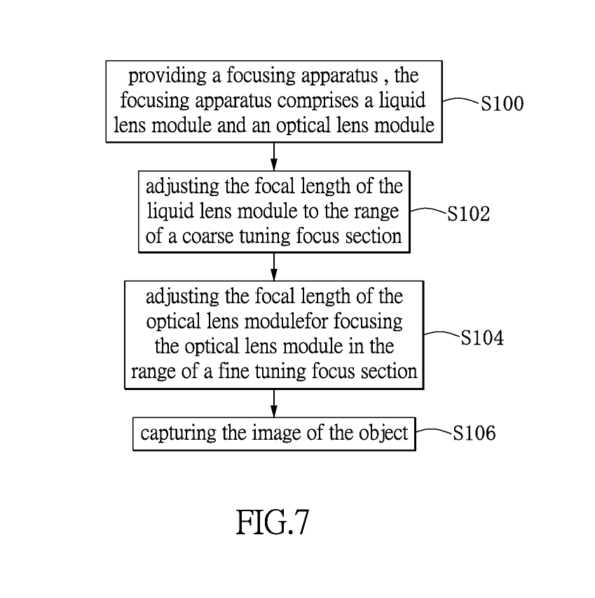

First, please refer to FIG. 6 and FIG. 7, and refer to FIG. 1 as needed. The second embodiment of the instant disclosure provides a focusing method comprising the following steps. As shown in step S100: providing a focusing apparatus L, the focusing apparatus L comprises a liquid lens module 11 and an optical lens module 12. Specifically, the liquid lens module 11 has a plurality of first predetermined focus sections F1, the optical lens module 12 has a plurality of second predetermined focus sections F2. Preferably, step S100 can further provide an image capturing device 2, the image capturing device 2 is disposed corresponding to the liquid lens module 11 and the optical lens module 12 for capturing the image of the object.

Step S100 may further comprise: providing a control device 4, the control device 4 is electrically connected to the image capturing device 2 and the focusing apparatus L for adjusting the focal length of the liquid lens module 11 and the focal length of the optical lens module 12. In addition, the image capturing device 2 can continuously capture the image of the object during the adjustment of the focal length of the liquid lens module 11 and the focal length of optical lens module 12.

The control device 4 also comprises an operation unit (not shown) for judging the image projected on the image capturing device 2 to find out if the current image is clear. In other words, the clarity (resolution) of the image is determined based on the contrast and sharpness of the image (the clarity value on the Y-axis shown in FIG. 6 presents the value of sharpness) calculated by the modulation transfer method MTF image resolution algorithm using the lens resolution of the control device 4.

In addition, step S100 preferably further comprises providing a focal length adjustment device 3. The focal length adjustment device 3 can be disposed on the optical lens module 12 or the image capturing device 2, and the focal length adjustment device 3 is electrically connected to the control device 4. The focal length of the optical lens module 12 can be changed by the control of the control device 4. The specific structures of the lens device 1, the image capturing device 2, the focal length adjustment device 3 and the control device 4 are described in the first embodiment.

The image with correct focus can be obtained by the control device 4 judging the focal length of the liquid lens module 11 and the focal length of the optical lens module 12. In other words, if the edges of the image significantly change, i.e., the differences between the gray scale values and the gradient values of the adjacent pixels become larger, the captured image is a clear image. Based on the above properties, the resolution value information for the judging standard can be obtained by processing of the control device 4 based on the image captured by the image capturing device 2. In addition, for example, in the embodiments of the instant disclosure, the control device 4 can be a microcontroller unit (MCU). However, the instant disclosure is not limited thereto. In addition, the control device 4 can control the focusing distance of the liquid lens module 11 and the optical lens module 12 when judging the clarity of the image.

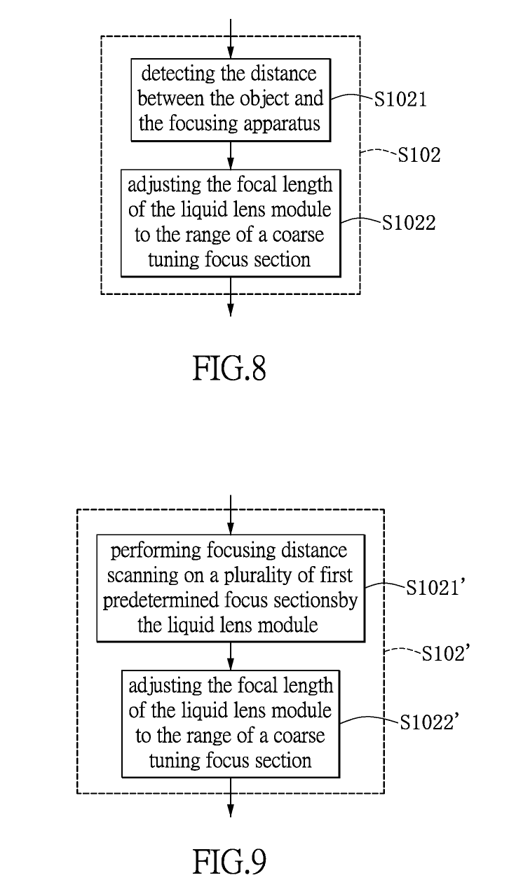

Next, as shown in step S102, the focal length of the liquid lens module 11 is adjusted for focusing the liquid lens module 11 in the range of a coarse tuning focus section R. Specifically, as shown in FIG. 8, in the second embodiment of the instant disclosure, step S102 includes step S1021: detecting the distance between the object and the focusing apparatus L, and step S1022: adjusting the focal length of the liquid lens module 11 to the range of a coarse tuning focus section R.

Specifically, as shown in step S1021, general focusing techniques can be divided into two types, the open loop type and the close loop type. In the second embodiment, the focusing method is an open loop type, i.e., using a laser distance meter, infrared distance meter, radar, sonic or supersonic wave to detect the distance between the object and the focusing apparatus L (for example, by a look up table), then performing focusing based on the above distance (please refer to step S1022). The close loop process will be described in the third embodiment.

Next, as shown in step S1022, locating the object in the coarse tuning focus section R by adjusting the focal length of the liquid lens module 11 based on the distance between the object and the focusing apparatus L obtained in step S1021. Specifically, the focal length of the liquid lens module 11 can be changed by the control device 4, and the liquid lens module 11 can focus in one of the first predetermined focus sections F1 as the range of the coarse tuning focus section R for locating the object in the coarse tuning focus section R. In other words, the coarse tuning focus section R is the first predetermined focus section F1 having the image of the object with best image resolution in the plurality of first predetermined focus sections F1.

As shown in FIG. 6, the liquid lens module 11 has a plurality of first predetermined focus sections F1 designed in advance, each different first predetermined focus section F1 has a plurality of second predetermined focus sections F2. In addition, the image of the object with good focus has higher clarity. Therefore, the focusing method comprises the step of first roughly focusing on the position of the object by the fast-focusing property of the liquid lens module 11, i.e., focusing the liquid lens module 11 in the coarse tuning focus section R and hence, the object is located in the coarse tuning focus section R. Therefore, the control device 4 can adjust the focal length of the liquid lens module 11 based on the distance detected in step S1021 for locating the object in the coarse tuning focus section R. During the process of adjusting the liquid lens module 11, the image of the object can be continuously captured by the image capturing device 2, and the calculation carried out in the control device 4 is able to judge whether the image of the object is located in the range of the coarse tuning focus section R. When the object is located in the coarse tuning focus section R, step S104 is performed to adjust the focal length of the optical lens module 12.

Next, as shown in step s104, focusing the optical lens module 12 in the range of a fine tuning focus section D by adjusting the focal length of the optical lens module 12. Specifically, the liquid lens module 11 is focused on a first predetermined focus section F1 having the image of the object with the best image resolution, i.e., the coarse tuning focus section R. Next, the focal length of the optical lens module 12 can be adjusted in the coarse tuning focus section R to focus in one of the second predetermined focus sections F2 as the range of a fine tuning focusing section D, thereby locating the object in the fine tuning focus section D. In other words, the fine tuning focus section D is the focusing section with correct focus, i.e., the fine tuning focus section D is a second predetermined focus section F2 having the image of the object with the best image resolution.

Furthermore, preferably, in order to focus the optical lens module 12 at one of the second predetermined focus sections F2 as a fine tuning focus section D, i.e., to focus the optical lens module 12 on the object for obtaining the image of the object with best image resolution, in step S104, the image of the object can be continuously captured in the step of adjusting the focal length of the optical lens module 12 to judge whether the object is located in the fine tuning focus section D. The optical lens module 12 is able to locate the object in the fine tuning focus section D by being driven by the focal length adjustment device 3 and the calculation results obtained by the image projected on the image capturing device 2 carried out by the control device 4.

Therefore, the control device 4 determines whether the step S106 can be carried out based on the fact that whether the object is located in the fine tuning focus section D. When the object is located in the fine tuning focus section D, the step S106 can be performed. When the object is not located in the fine tuning focus section D, the control device 4 continues to perform the focusing process of the optical lens module 12 on the object until the optical lens module 12 is focused in the range of a fine tuning focus section D.

As shown in step S106: capturing the image of the object. For instance, since the optical lens module 12 is focused on the object, the object can be captured for obtaining the image thereof. However, step S106 is an optional step and can be omitted in some embodiments based on user requirements.

### Third Embodiment

First, please refer to FIG. 7 and FIG. 9. By comparing FIG. 9 with FIG. 8, the difference between the second embodiment and the third embodiment is that the third embodiment employs a close loop type focusing process. Since step S100, step S104 and step S106 are similar to that of the second embodiment, the details thereof are not described.

Please refer to FIG. 9. As shown in step S102′, adjusting the focal length of the liquid lens module 11 for focusing the liquid lens module 11 in the range of a coarse tuning focus section R. Specifically, in the third embodiment of the instant disclosure, step S102′ comprises step S1021′: performing focusing distance scanning on a plurality of first predetermined focus sections F1 by the liquid lens module 11, and step S1022′: adjusting the focal length of the liquid lens module 11 to the range of a coarse tuning focus section R. Therefore, the focusing distance scanning performed by the liquid lens module 11 on the plurality of first predetermined focus sections F1 enables the liquid lens module 11 to focus in the coarse tuning focus section R.

Specifically, as shown in FIG. 6 and step S1021′, the liquid lens module 11 can be used in conjunction with the control device 4 and the image capturing device 2 to perform focusing distance scanning on a plurality of first predetermined focus sections F1. For instance, the liquid lens module 11 can judge the slope value in the current scanned first predetermined focus section F1 to determine whether the image resolution has become better.

Next, as shown in step S1022′, adjusting the focal length of the liquid lens module 11 based on the result of the focusing distance scanning of the plurality of first predetermined focus sections F1 for focusing the liquid lens module 11 in the range of the coarse tuning focus section R. In other words, the liquid lens module 11 can focus in the coarse tuning focus section R based on the calculation of the control device 4, and then performing the follow-up steps.

The calculation of the control device 4 can determine whether the object is located in the coarse tuning focus section R, and when the object is located in the coarse tuning focus section R, the control device 4 performs the step of adjusting the focal length of the optical lens module 12, and when the object is not located in the coarse tuning focus section R, the control device 4 continues to adjust the liquid lens module 11 to perform scanning on the plurality of first predetermined focus sections F1.

### The Effectiveness of the Embodiments

In summary, the focusing apparatus L and the focusing method thereof provided by the embodiments of the instant disclosure first utilize the property of fast-moving and large displacement during focal length adjustment (fast focus surface adjustment of about <10 ms) of the liquid lens module 11 to perform long-distance movement for roughly focusing in the coarse tuning focus section R comprising the object.

Subsequently, the optical lens module 12 performs the focusing process on the object in the coarse tuning focus section R and the more accurate focusing property of the optical lens module 12 is used to focus the optical lens module 12 in the fine tuning focus section D. Therefore, by sequentially employing the liquid lens module 11 and the optical lens module 12, the instant disclosure can focus on the object quickly. In other words, the instant disclosure first quickly moves the liquid lens module 11 to the coarse tuning focus section R and hence, the optical lens module 12 only has to perform a small distance movement in the coarse tuning focus section R. Accordingly, the displacement of the optical lens module 12 of the focal length adjustment device 3 is smaller and can avoid the vibration of the optical lens module 12, and the moving speed of the optical lens module 12 can be faster.

The above-mentioned descriptions represent merely the exemplary embodiment of the present disclosure, without any intention to limit the scope of the instant disclosure thereto. Various equivalent changes, alterations or modifications based on the claims of the instant disclosure are all consequently viewed as being embraced by the scope of the instant disclosure.

What is claimed is:

1. A focusing method, comprising:
providing a focusing apparatus, the focusing apparatus comprises a liquid lens module and an optical lens module, wherein the liquid lens module has a plurality of first predetermined focusing sections, the optical lens module has a plurality of second predetermined focusing sections;
adjusting the focus length of the liquid lens module based on an object for focusing the liquid lens module in one of the first predetermined focusing sections as a range of a coarse tuning focus section, the image of the object is located in the range of the coarse tuning focus section; and
adjusting the focal length of the optical lens module in the coarse tuning focus section for focusing the optical lens module in one of the second predetermined focusing sections as a range of a fine tuning focus section, the image of the object is located in the range of the fine tuning focus section;
wherein the coarse tuning focus section is one of the first predetermined focus sections and has an image with best image resolution.

2. The focusing method according to claim 1, wherein in the step of adjusting the focus length of the liquid lens module, further comprising:
detecting a distance between the object and the focusing apparatus; and
adjusting the focus length of the liquid lens module based on the distance between the object and the focusing apparatus.

3. The focusing method according to claim 2, wherein in the step of adjusting the focal length of the optical lens module, the optical lens module performs an auto-focusing process in the coarse tuning section for locating the object in the fine tuning section.

4. The focusing method according to claim 1, wherein in the step of adjusting the focus length of the liquid lens module, further comprising:
performing focusing distance scanning on the plurality of first predetermined focus sections; and
adjusting the focal length of the liquid lens module to the range of the coarse tuning focus section based on the result of the focusing distance scanning.

5. The focusing method according to claim 4, wherein in the step of adjusting the focus length of the optical lens module, the optical lens module performs auto-focusing in the coarse tuning focus section for locating the object in the fine tuning focus section.

6. The focusing method according to claim 1, wherein the fine tuning focus section is one of the second predetermined focus sections having an image with best image definition.

7. The focusing method according to claim 1, wherein in the step of providing the focusing apparatus, further comprising:
providing an image capture device for capturing an image of the object; and
providing a control device for adjusting the focal length of the liquid lens module and the focal length of the optical lens module based on the image of the object.

8. The focusing method according to claim 7, wherein in the step of adjusting the focal length of the liquid lens module by the image capturing device and in the step of adjusting the focal length of the optical lens module, further comprising:
continuously capturing the image of the object.

9. The focusing method according to claim 8, wherein the control device judges whether the object is located in the coarse tuning focus section based on the image of the object, or judges whether the object is located in the fine tuning focus section based on the image of the object, when the object is located in the coarse tuning focus section, performing the step of adjusting the focal length of the optical lens module, when the object is not located in the coarse tuning focus section, continuing to adjust the liquid lens module.

10. A focusing device, comprising:
a lens device comprising:
a liquid lens module, wherein the liquid lens module comprises a liquid lens unit;
an optical lens module, the optical lens module is disposed corresponding to the liquid lens module, wherein the optical lens module comprises an optical lens unit; and
a central axis passing the liquid lens module and the optical lens module;
an image capturing device, the image capturing device is disposed corresponding to the lens device;
a focal length adjustment device disposed on the optical lens module or the image capturing device for driving the optical lens module or the image capturing device to change the focal length of the optical lens module; and
a control device electrically connected to the lens device, the image capturing device and the focal length adjustment device for controlling the focal length of the liquid lens module and the optical lens module.
